(19) United States
(12) Patent Application Publication
(10) Pub. No.: US 2007/0283166 A1
(43) Pub. Date: Dec. 6, 2007

(54) System and method for state transition intrusion detection

(75) Inventors: Sameer Yami, Irvine, CA (US); Peter Tran, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/446,910

(22) Filed: Jun. 5, 2006

(51) Int. Cl. G06F 12/14

(52) U.S. Cl. 713/187

(57) ABSTRACT

A system and method for state transition intrusion detection is provided. The system and method employ a state transition file, containing a listing or table of all available state transitions associated with a given operation. A log file is then generated using state transition data gathered during the performance of a given operation. Depending upon the instructions present in the state transition file, one or more state transitions in the log file are digitally signed. To determine if an intrusion has occurred, the log file is analyzed, state transition by state transition. This analysis is accomplished by comparing the signatures associated with the state transitions in the log file with those signatures contained in the state transition file, thereby detecting any erroneous signatures. Each operation capable of being performed is accounted for in the state transition file such that all available state transitions associated with the operation are stored in the file. The type of operation represented in the log file is then determined and the transitions contained in the log file are compared to those transitions associated with the operation type in the state transition file. Any missing state transitions denote tampering or modification of the log file, indicating an intrusion, whereupon an administrator is notified.

### BACKGROUND OF THE INVENTION

The subject application is directed to a system and method for state transition intrusion detection. More particularly, the subject application is directed to a system and method for storing state transitions in an encrypted file and using the stored state transitions as a reference for determining any intrusions or tampering.

In a document processing device or system, it is important to be able to detect if an unauthorized user or intruder has gained access to the device or system. Current intrusion detection systems are able to proactively detect intrusions at the network level. However, the device or system may have been compromised even though there is no anomaly or intrusion evident at the network level as the intruder may have been able to bypass detection, or planted a rogue program that itself is not evident. For example, the unauthorized user may have been able to bypass the password lookup requirement during a secure print operation or intercept a data transmission and transmit it to the intruder or save it for later review.

In addition to the forgoing, more sophisticated intrusions may themselves mask or alter log files that track progress of an application. It would be desirable to have a system and method that was able to detect any such attempted intrusion, interception or tampering.

The subject application overcomes the above mentioned problems and provides a system and method for state transition monitoring that accomplishes detection of attempts to infiltrate a system and assure that a machine is running as expected.

### SUMMARY OF THE INVENTION

In accordance with the subject application, there is provided a system and method for state intrusion detection.

Further, in accordance with the subject application, there is provided a system and method that provides real time intrusion detection based on state transition information.

Still further, in accordance with the subject application, there is provided a system for state intrusion detection. The system includes a storage having means adapted for storing executable code defining transitions between a plurality of states of an associated device and means adapted for storing an encrypted state table representative of acceptable state transitions defined in the executable code. The system also includes monitoring means adapted for monitoring transitions between the plurality of states during execution of the code and comparison means adapted for comparing monitored state transitions to the state table. The system further comprises means adapted for generating an output representative of an unacceptable state transition in accordance with an output of the comparison means.

Still further, in accordance with the subject application, there is provided a method for state intrusion detection. The method stores executable code defining transitions between a plurality of states of an associated device and an encrypted state table representative of acceptable state transitions defined in the executable code. Transitions between the plurality of states during execution of the code are monitored and compared to the state table. An output representative of an unacceptable state transition is then generated in accordance with an output of the comparison of the monitored state transitions to the state table.

In a preferred embodiment, the state table is signed to facilitate detection of modification thereto.

In one embodiment, the system and method include the ability to identify a location of an alteration in the executable code in accordance with an output of the comparing the monitored state transitions. Preferably, such output is directed to an associated log file. More preferably, an unacceptable state transition occurs during a modification to the associated log file.

In another embodiment, the system and method also include the ability to generate a signing output representative of instructions in the executable code for which signing is required for use in the step of comparing monitored state transitions to the state table. Preferably, the system and method further include generating of signing keys during execution of the executable code.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall system diagram of the system for state intrusion detection according to the subject application;

FIG. 2 is a block diagram illustrating controller hardware for use in the system for state intrusion detection according to the subject application;

FIG. 3 is a functional block diagram illustrating the controller for use in the system for state intrusion detection according to the subject application;

FIG. 4 is a flowchart illustrating the method for state transition data generation in a state intrusion detection system according to the subject application;

FIG. 5 is a flowchart illustrating the method for state intrusion detection according to the subject application; and

FIG. 6 is a flowchart illustrating the real-time method for state intrusion detection according to the subject application.

### DETAILED DESCRIPTION OF THE PREFERRED EMBODIMENT

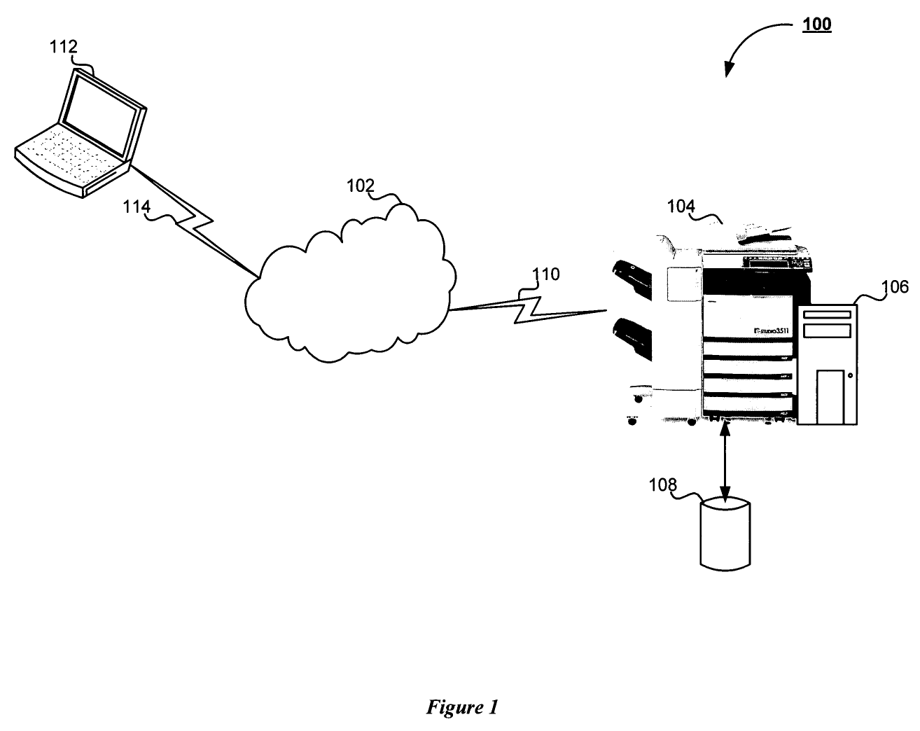

The subject application is directed a system and method for state intrusion detection. In particular, the subject application is directed to a system and method that provides real time intrusion detection based on state transition information. Turning now to FIG. 1, there is depicted a diagram illustrating an overall system 100 for secure inter-process communications in accordance with the subject application. As shown in FIG. 1, the system 100 includes a distributed computing environment, represented as a computer network 102. It will be understood by those skilled in the art that the computer network 102 is any distributed communications environment known in the art capable of enabling the exchange of data between two or more electronic devices. The skilled artisan will further understand that the computer network 102 is any computer network, known in the art, including for example, and without limitation, a local area network, a wide area network, a personal area network, a virtual network, an intranet, the Internet, or any combination thereof. In the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wire-based or wireless data communication mechanisms.

Communicatively coupled to the computer network 102 via a suitable communications link 110, is a document processing device 104. It will be appreciated by those skilled in the art that the document processing device 104 is advantageously represented in FIG. 1 as a multifunction peripheral device, suitable adapted to provide a variety of document processing operations. The skilled artisan will understand that such document processing operations include, for example and without limitation, copying, scanning, electronic mail, document management, facsimile, printing, and the like. Suitable commercially available document processing devices include, but are not limited to, the Toshiba e-Studio Series Controller. In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the subject application, the document processing device 104 further includes an associated user-interface, such as a touch-screen interface, LCD display, or the like, via which an associated user is able to interact directly with the document processing device 104. As will be appreciated by the skilled artisan, a suitable communications links 110 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

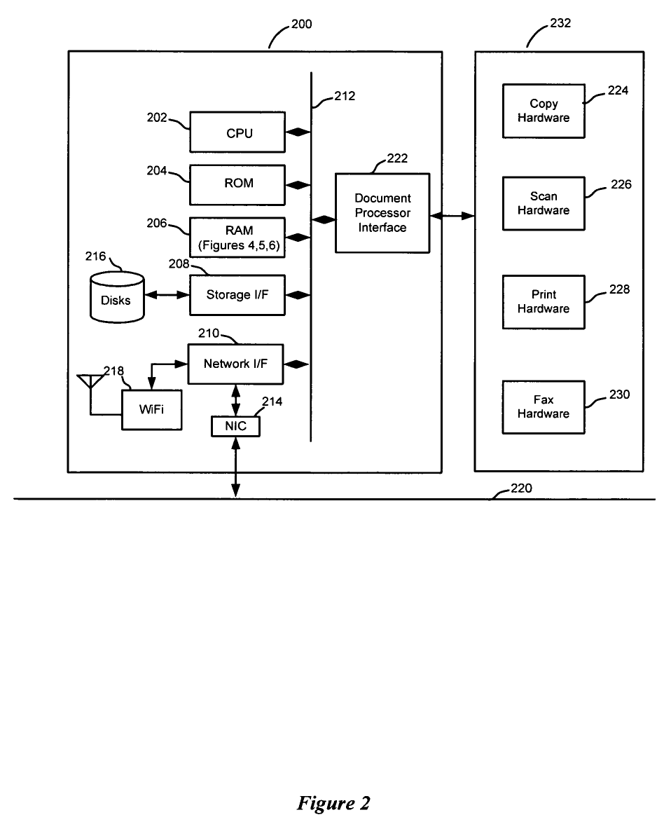

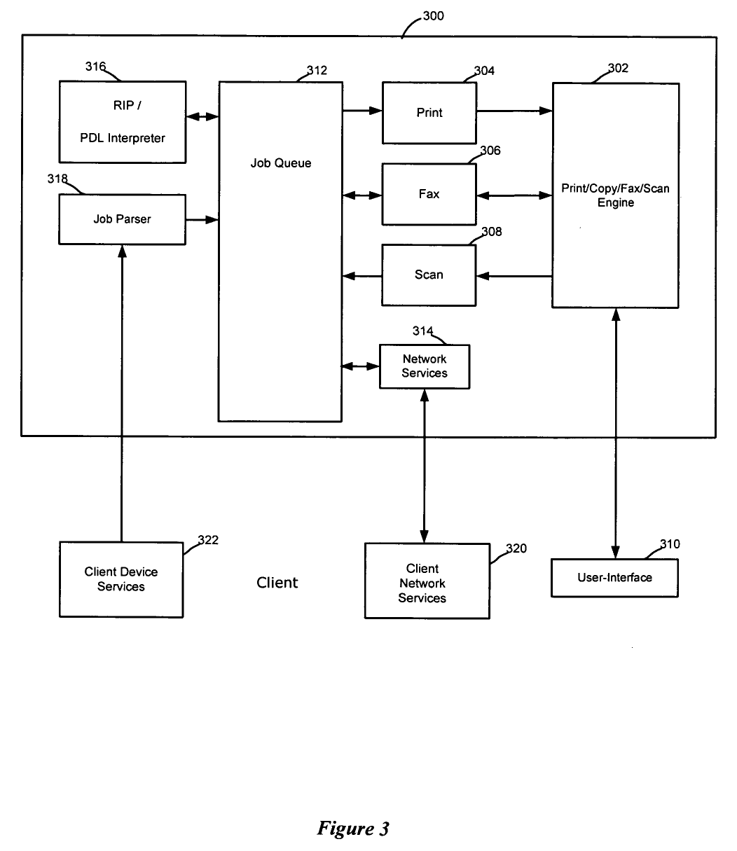

Operatively coupled to the document processing device 104 is a controller 106, as illustrated in FIG. 1. As will be appreciated by those skilled in the art, the controller 106 is any software, hardware, or combination thereof, suitably adapted to provide control functionality to the document processing device 104. In accordance with the subject application, the controller 106 is suitably adapted to generate log and audit data representative of document processing operations performed by the document processing device 104. Further in accordance with the subject application, the controller 106 is advantageously capable of monitoring document processing operations, generating transition state data, maintaining a state transition file, and the like. While illustrated in FIG. 1 as being a separate component of the system 100, the skilled artisan will appreciate that the controller 106 is capable of implementation as an internal component of the document processing device 104, without departing from the scope of the subject application. The functioning of the controller 106 will be better understood in conjunction with the block diagrams illustrated in FIG. 2 and FIG. 3, discussed in greater detail below.

The system 100 further includes a data storage device 108, communicatively coupled to the document processing device 104. Preferably, the data storage device 108 is suitably adapted to provide storage services to the operations running on the document processing device 104. As will be appreciated by those skilled in the art, the data storage device 108 is any mass storage device known in the art including, for example and without limitation, a hard disk drive, other magnetic storage devices, optical storage devices, flash memory devices, or any combination thereof. In the preferred embodiment of the subject application, the data storage device 108 is capable of storing log data, state transition data, and the like. It will be appreciated by those skilled in the art that while illustrated in FIG. 1 as being a separate component of the system 100, the data storage device 108 is capable of being implemented as internal storage of the document processing device 104, such as, for example and without limitation, an internal hard disk drive, or the like.

As depicted in FIG. 1, the system 100 includes at least one client device 112 in data communication with the computer network 102 via a suitable communications link 114. It will be appreciated by those skilled in the art that the client device 112 is depicted in FIG. 1 as a laptop computer for illustration purposes only. As the skilled artisan will understand, the client device 112 shown in FIG. 1 is representative of any personal computing device known in the art, including, for example and without limitation, a computer workstation, a personal computer, a personal data assistant, a web-enabled cellular telephone, a smart phone, or other web-enabled electronic device suitably capable of generating document processing operations and transmitting the same to a multifunctional peripheral device. The communications link 114 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Turning now to FIG. 2, illustrated is a representative architecture of a suitable controller 200, shown in FIG. 1 as the controller 106, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In the preferred embodiment of the subject application, the data storage device 108, includes a list or table of all available state transitions corresponding to operations performed by the document processing device 104 in a state transition file. Preferably, the list or table of all available state transitions is stored on the data storage device 108 in an extensible markup language file. In accordance with one aspect of the subject application, the state transition file further includes data representative of instructions to require signing of certain transitions, as set forth by a system administrator. In addition, the state transition file is preferably encrypted and digitally signed, so as to prevent tampering of the file and restrict access only to those users authorized to modify the file. In order to monitor and detect intrusions, the system 100 employs a log file, which stores state transition data corresponding to each state transition made during an operation.

The populating of the log file is accomplished by assigning, after receipt of state transition data, a unique identifier to the state transition. Once the unique identifier has been assigned to that state transition data, a determination is made whether the state transition file indicates that this state transition data is to be signed. When the state transition data does not require signing, the transition data is stored in the log file, associated with the current operation. When the state transition data requires signing, as set forth by the instructions of the state transition file, the state transition data is signed via any suitable means known in the art. The signature and transition data is then stored in the log file. The skilled artisan will appreciate that this process is repeated until all state transitions of the current operation have been performed. Stated differently, each operation comprises executable code defining transitions between states of the document processing device, whereby the completion of an operation coincides with the completion of the execution of such code, resulting in a log file. It will further be appreciated by those skilled in the art that the log file is capable of being maintained on the data storage device 108 such that each successive operation performed by the document processing device 104 is also monitored and the state transition data is stored thereon.

The analysis and detection of intrusions by unauthorized parties is advantageously accomplished using the log file generated during the performance of operations by the document processing device 104. To analyze this file for the detection of anomalies, i.e., evidence of intrusion, the controller 106, or other hardware, software, or combination thereof, in operative connection with the data storage device 108 retrieves the log file and the state transition file. It will be appreciated that while the subject application directs the use of the controller 106 component of the document processing device 104 to perform the analysis, the subject application is not limited to the controller 106 performing such analysis. The skilled artisan will appreciate that any administrative device, known in the art, capable of interfacing with the data storage device 108, is capable of being implemented to perform analysis of the data stored thereon.

As previously stated, the state transition file is encrypted, so as to prevent unauthorized access thereto, thus requiring the controller 106 to first decrypt the file for access to the state transition list or table stored thereon. Once the state transition file has been decrypted and opened for reading by the analyzing controller 106, the first state transition data, associated with the first operation, is retrieved from the log file. It will be appreciated by those skilled in the art that such retrieval of transition data is advantageously performed on a line-by-line basis of the log file. The skilled artisan will further appreciate that other methodologies of retrieval, as are known in the art, are equally capable of being implemented in accordance herewith. Once the first state transition data has been retrieved, the controller 106 then determines whether or not the transition data is required to be signed, as will be understood by those skilled in the art. When the first state transition does not require a signature, the controller 106 retrieves the next state transition data from the log file and proceeds to determine whether it requires signing.

When the state transition data is required to be signed, the signature attached to the transition data of the log file is compared to the signature stored in the state transition file. When the signatures do not match, an error notification is made to a system administrator, noted in the log, or the like. When the signatures do match, the controller 106 determines whether any additional state transition data remains in the log file associated the operation being currently analyzed. When any additional transitions remain, the next transition data is retrieved and the process repeats. When no additional state transition data remains, the type of operation is determined by the controller 106 from the log file and used to retrieve the corresponding state transition data from the state transition file. That is, the controller 106 retrieves all the state transitions from the state transition file that should be present in the identified operation type. When one or more transition states are missing, indicating tampering, notification is sent to the administrator, noted in the log file, or the like. The controller 106 then retrieves the next operation from the log file and the analysis continues from there as set forth above.

In performing real-time analysis and intrusion detection, the system 100 employs the controller 106, or other software, hardware, software/hardware combination, to continually monitor the data of the log file. Preferably, such monitoring occurs following the performance of each new operation performed by the document processing device 104. For purposes of example only, the subject application employs the controller 106 as a real-time monitoring component of the system 100. Those skilled in the art will appreciate, however, that an administrative device, in data communication with the document processing device 104, is equally capable of performing the real-time intrusion detection, as contemplated herein. Upon the elapse of a predetermined period of time, as set by the administrator or the like, the log file is retrieved by the controller 106 and the last verified operation identification data is gathered. The last verified operation identification data is preferably contained within the log file and corresponds to the last operation that was analyzed and verified as being free from intrusion. Using the identification data, the controller 106 searches the log file for the next succeeding operation performed by the document processing device 104. The skilled artisan will understand that the succeeding operation is the next operation performed temporally, i.e., in chronological order, based upon the identification data. The controller 106 then retrieves the first state transition data from the log file and performs the comparison with the state transition file, as explained above. A notification is generated upon the determination that the signatures of state transition data of the log file and the transition file do not match and sent to the administrator, or the like. When the signatures of are valid, the state transitions associated with the current operation are retrieved from the state transition file and compared with the state transition data of the log file to determine whether any state transitions are missing. When one or more state transitions are not present in the log file for the current operation, a notification is generated and sent to an appropriate administrator, noted in the log file, or the like. When the controller 106 determines that the state transitions of the log file matches that of the state transition file, the current operation is saved as the last verified operation and the system 100 returns to waiting for a new operation.

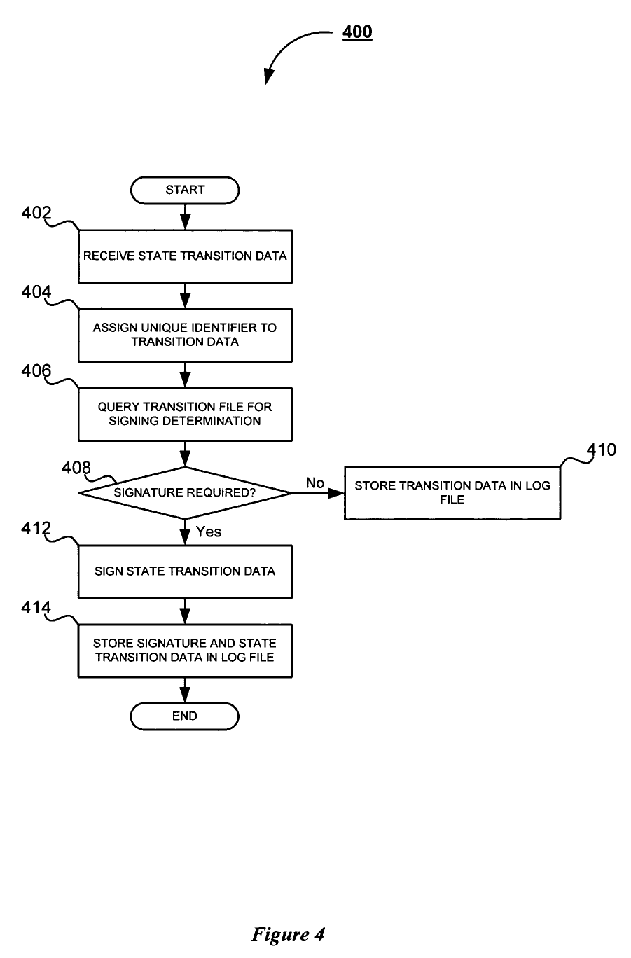

The foregoing system 100 and components shown in FIG. 1, FIG. 2, and FIG. 3 will better be understood when viewed in conjunction with the flowcharts illustrated in FIGS. 4, 5, and 6. Referring now to FIG. 4, there is shown a flowchart 400 illustrating a method for state transition data generation in a state intrusion detection system in accordance with the subject application. At step 402, state transition data is received by the controller 106 representative of the transition from one state of the document processing device 104 to another state in accordance with a selected document processing operation. A unique identifier is then assigned to the received state transition data at step 404. At step 406, a query is made to the state transition file for signing determination. It will be appreciated by those skilled in the art that the query of the state transition file, which is stored on the storage device 108 in encrypted form, must first be decrypted. Thus, after decrypting the data contained within the state transition file, the controller 106 is able to proceed with searching the file signing determination data. A determination is then made by the controller 106 at step 408 to determine whether the state transition data is to be signed. The skilled artisan will appreciate that the data contained in the state transition file includes instructions for signing a particular state transition or not.

When it is determined at step 408 to not sign the received state transition data, flow proceeds to step 410, whereupon the state transition data is stored in the log file. When the state transition data is to be signed, flow progresses to step 412, whereupon the controller 106 digitally signs the state transition data in accordance with the instructions retrieved from the state transition file. The signed state transition data is then stored in the log file at step 414. It will be understood by those skilled in the art that steps 402 through step 414 are repeated for each state transition performed for the selected document processing operation. It will further be appreciated by the skilled artisan that the state transition data for each subsequent state transition, whether or not signed, is also stored in the log file. The skilled artisan will further understand that the log file is also capable of being updated in accordance with the methodology described in FIG. 4, resulting in the presence of audit data of multiple operations in the log file.

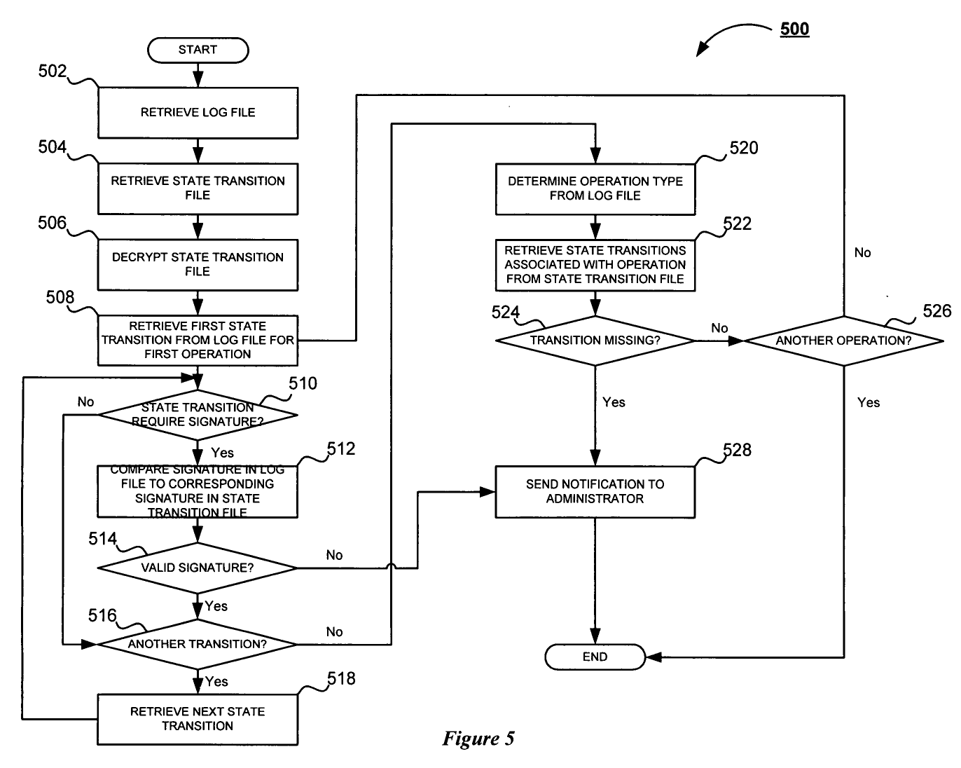

Turning now to FIG. 5, there is shown a flowchart 500 illustrating a method for state intrusion detection in accordance with the subject application. It will be understood by those skilled in the art that while the controller 106 is referenced hereinafter as performing the analysis and detection, the subject application is not limited solely to a component of the document processing device, but rather is capable of being performed by any computing device known in the art, e.g., an administrative device, laptop, personal computer, and the like. The method begins at step 502 with the retrieval of the log file from the data storage device 108. The state transition file is then retrieved by the controller 108 at step 504. As previously discussed, the state transition file, in addition to containing digitally signed data, is stored in the data storage device 108 in an encrypted format, so as to protect the file from alteration by unauthorized users. Preferably, the state transition file is encrypted using any suitable encryption methodologies known in the art. A suitable encryption methodology includes, for example and without limitation, key pairs. The state transition file is then decrypted at step 506, whereupon the file is readied for access by the controller 106.

The first transition data is retrieved from the log file corresponding to the first operation in the log file at step 508. A determination is then made at step 510 whether the state transition requires a digital signature, i.e., whether the state transition data must be digitally signed. When it is determined that a signature is required for the given state transition data, flow proceeds to step 512, whereupon the signature in the log file is compared to the signature of the state transition file of the given state transition. A determination is then made at step 514 whether the signature of the log file is valid. When the signature is not valid at step 514, flow proceeds to step 528, whereupon a notification is sent to an administrator, thereby notifying the administrator of the detected anomaly. When the signature is valid, flow proceeds to step 516, whereupon a determination is made whether another state transition is present in the log file. When additional state transitions remain in the log, flow proceeds to step 518, whereupon the next state transition is retrieved from the log file. Following retrieval of the next state transition in the log file, flow returns to step 510, whereupon the controller 106 determines whether the next state transition requires a digital signature, thereafter operations proceed as discussed above.

When it is determined at step 516 that no additional state transitions remain in the log file for the current operation being analyzed, flow proceeds to step 520, whereupon the operation is determined from the log file. That is, the executable code defining the transitions between states of the document processing device is determined as to type, i.e., a copy operation, a print operation, a facsimile operation, or the like. As will be appreciated by those skilled in the art, the type of operation necessarily dictates the state transitions that should be present in the log file. Thus, the controller 106 thereafter retrieves the state transitions associated with the current operation from the state transition file at step 522. A determination is then made at step 524 whether any state transitions are missing from the log file. That is, the controller 106 compares the list of state transitions that should be present in the current operation type, as stored in the state transition file, to the state transitions present in the log file corresponding to the current operation being analyzed. When one or more state transitions are missing, a notification is transmitted to the administrator, informing the administrator of the anomaly and possible intrusion. When no state transitions are missing, flow proceeds to step 526, whereupon a determination is made whether the log file contains state transition data associated with another operation. When another operation is present in the log file, flow returns to step 508, whereupon the first state transition of the next operation is retrieved from the log file and processing continues thereon, as set forth above. When no additional operations remain in the log file, the operation terminates.

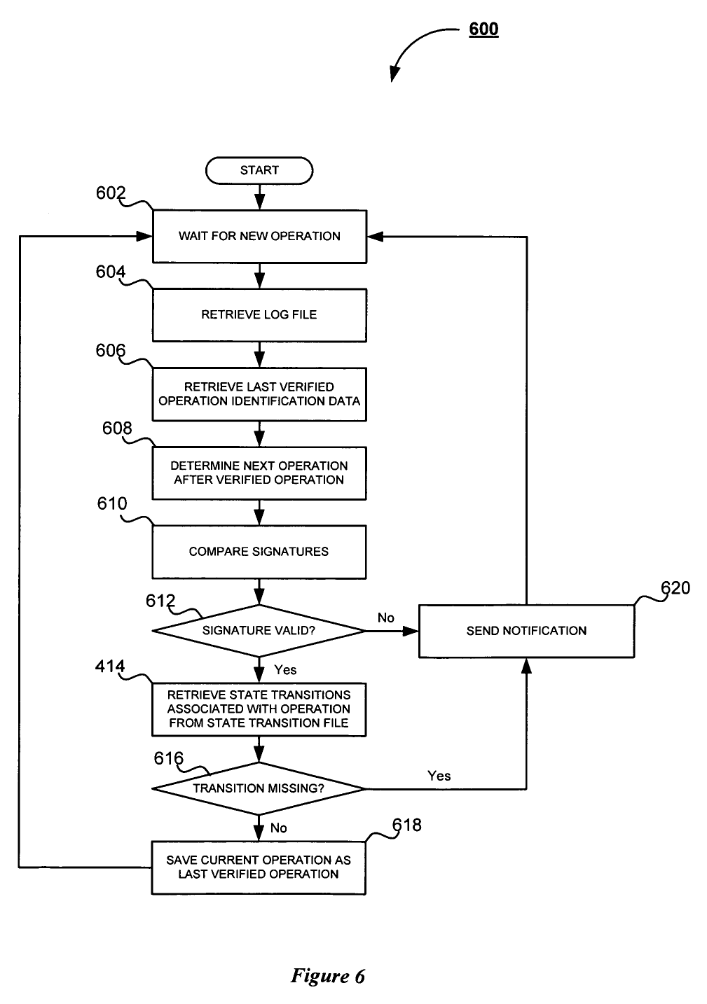

Referring now to FIG. 6, there is shown a flowchart 600 illustrating a real-time method for state intrusion detection in accordance with the subject application. The controller 106, or other monitoring/detection component of the document processing device 104, as will be known to those skilled in the art, waits at step 602 for a new operation to be performed by the document processing device 104. Preferably, the controller 106 waits a predetermined period of time prior to retrieving, at step 404, the log file. The skilled artisan will appreciate that step 602 is not limited solely to the elapse of a predetermined period of time, but rather is capable of employing the controller 106 to detect the completion of each document processing operation, which thereafter prompts the controller 106 to retrieve, at step 604, the log file.

Once the log file has been retrieved, flow proceeds to step 606, whereupon the last verified operation identification data is retrieved from the log file. Preferably, the data is representative of the most recently verified operation. At step 608, the controller 106 determines the next operation in the log file following the verified operation. As will be understood by those skilled in the art, the next operation refers to the next subsequent, or next most recent in time, operation performed by the document processing device 104 and recorded in the log file. At step 610, the signatures of the state transitions recorded in the log file are then compared to the signatures stored in the state transition file, as set forth above with respect to FIG. 5.

A determination is then made at step 612 whether the signatures are valid, in the same manner as explained above. When the signatures are not valid, flow proceeds to step 420, whereupon a notification is transmitted to an administrator, thereby informing the administrator of the detected anomaly or intrusion. When the signatures are valid, flow proceeds from step 612 to step 614, whereupon the state transitions associated with the current operation type are retrieved from the state transition file. The methodology by which such retrieval is accomplished, set forth in FIG. 5, is explained in greater detail above. A determination is then made at step 616 whether one or more transitions are missing from the log file that should be present, as indicated by the content of the state transition file. When one or more state transitions are missing, flow proceeds to step 620 for reporting of such anomalies or intrusions to the administrator. When no state transitions are missing from the log file, flow progresses to step 618, whereupon the current operation is saved as the last verified operation. Flow then returns to step 602, whereupon the controller 106 waits for the performance of a new operation by the document processing device 104.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A state transition intrusion detection system comprising:
a storage including means adapted for storing executable code defining transitions between a plurality of states of an associated device;
the storage including means adapted for storing an encrypted state table representative of acceptable state transitions defined in the executable code;
monitoring means adapted for monitoring transitions between the plurality of states during execution of the code;
comparison means adapted for comparing monitored state transitions to the state table; and
means adapted for generating an output representative of an unacceptable state transition in accordance with an output of the comparison means.

2. The state transition intrusion detection system of claim 1 wherein the state table is signed to facilitate detection of modification thereto.

3. The state transition intrusion detection system of claim 2 further comprising means adapted for identifying a location of an alteration in the executable code in accordance with an output of the comparison means.

4. The state transition intrusion detection system of claim 3 wherein an output of the comparison means is directed to an associated log file.

5. The state transition intrusion detection system of claim 4 wherein an unacceptable state transition occurs during a modification to the associated log file.

6. The state transition intrusion detection system of claim 1 further comprising:
means adapted for generating a signing output representative of instructions in the executable code for which signing is required; and
means adapted for communicating the signing output into the comparison means.

7. The state transition intrusion detection system of claim 6 further comprising means adapted for generating signing keys during execution of the executable code.

8. A state transition intrusion detection method comprising the steps of:
storing executable code defining transitions between a plurality of states of an associated device;
storing an encrypted state table representative of acceptable state transitions defined in the executable code;
monitoring transitions between the plurality of states during execution of the code;
comparing monitored state transitions to the state table; and
generating an output representative of an unacceptable state transition in accordance with an output of the comparison of the monitored state transitions.

9. The state transition intrusion detection method of claim 8 wherein the state table is signed to facilitate detection of modification thereto.

10. The state transition intrusion detection method of claim 9 further comprising the step of identifying a location of an alteration in the executable code in accordance with an output of the step of comparing the monitored state transitions.

11. The state transition intrusion detection method of claim 10 wherein an output of the step of comparing the monitored state transitions is directed to an associated log file.

12. The state transition intrusion detection method of claim 11 wherein an unacceptable state transition occurs during a modification to the associated log file.

13. The state transition intrusion detection method of claim 8 further comprising the step of generating a signing output representative of instructions in the executable code for which signing is required for use in the step of comparing monitored state transitions to the state table.

14. The state transition intrusion detection method of claim 13 further comprising the step of generating signing keys during execution of the executable code.

15. A computer-implemented method for state transition intrusion detection comprising the steps of:
storing executable code defining transitions between a plurality of states of an associated device;
storing an encrypted state table representative of acceptable state transitions defined in the executable code;
monitoring transitions between the plurality of states during execution of the code;
comparing monitored state transitions to the state table; and
generating an output representative of an unacceptable state transition in accordance with an output of the comparison of the monitored state transitions.

16. The computer-implemented method for state transition intrusion detection of claim 15 wherein the state table is signed to facilitate detection of modification thereto.

17. The computer-implemented method for state transition intrusion detection of claim 16 further comprising the step of identifying a location of an alteration in the executable code in accordance with an output of the step of comparing the monitored state transitions.

18. The computer-implemented method for state transition intrusion detection of claim 15 further comprising the step of generating a signing output representative of instructions in the executable code for which signing is required for use in the step of comparing monitored state transitions to the state table.

19. The computer-implemented method for state transition intrusion detection of claim 18 further comprising the step of generating signing keys during execution of the executable code.

20. The computer-implemented method for state transition intrusion detection of claim 15 wherein an unacceptable state transition occurs during a modification to an associated log file
